(19) United States
(12) Patent Application Publication
(10) Pub. No.: US 2026/0326844 A1
(43) Pub. Date: Oct. 22, 2026

(54) PICKUP TRUCK CAB EXTENSION AND METHOD

(71) Applicant: Chad Eddy, Emery, SD (US)

(72) Inventor: Chad Eddy, Emery, SD (US)

(21) Appl. No.: 19/468,728

(22) Filed: Feb. 3, 2026

Related U.S. Application Data
(60) Provisional application No. 63/753,032, filed on Feb. 3, 2025.

(51) Int. Cl. B62D 65/06; B62D 21/02; B62D 25/02; B62D 25/06

(52) U.S. Cl. CPC B62D 65/06; B62D 21/02; B62D 25/02; B62D 25/06

(57) ABSTRACT

A pickup truck cab extension and method provides for extending a four door pickup cab to a six door pickup cab. An extended inner frame is formed by joining a first extended section coming from a base vehicle and a second extended section from a donor frame. A pair of side panels is coupled to the extended inner frame. Each of the side panels is a seamless one-piece fiberglass side panel construction.

### CROSS-REFERENCE TO RELATED APPLICATIONS

I hereby claim the benefit under 35 U.S.C. Section 119(e) of U.S. Provisional application 63/753,032 filed Feb. 3, 2025.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pickup cab extensions and more particularly pertains to a new pickup cab extension and method for producing a structurally sound six door pickup truck.

### (2) Description of Related Art Including Information Disclosed Under 37 CFR 1.97 and 1.98

The prior art relates to vehicle extensions. Known methods for extending pickup truck cabs have proven incapable of producing a structurally sound extension of the cab, particularly for Ford brand pickup trucks after model year 2017 which were then made of aluminum. What is needed is a method for producing a six door pickup cab extension in which extension panels are structurally sound. On the aluminum bodies, the aluminum gets hot and warps, making it very hard to have a seamless look. The aluminum body on the Ford Super Duty models requires a new way to make the middle door for 6 door pickups eliminating the use of any body fillers on the cabs for seamless appearance and structural integrity.

### BRIEF SUMMARY OF THE INVENTION

An embodiment of the disclosure meets the needs presented above by generally comprising an extended inner frame is formed by joining a first extended section coming from a base vehicle and a second extended section from a donor frame. A pair of side panels is coupled to the extended inner frame. Each of the side panels is a seamless one-piece fiberglass side panel construction.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of an extended pickup cab device according to an embodiment of the disclosure.

FIG. 2 is a side view of an embodiment of the disclosure.

FIG. 3 is a side view of an embodiment of the disclosure.

FIG. 4 is a top view of an embodiment of the disclosure.

FIG. 5 is a side view of a base vehicle of an embodiment of the disclosure.

FIG. 6 is a side view of a donor cab frame of an embodiment of the disclosure.

FIG. 7 is a top front side perspective view of an extended inner cab frame of an embodiment of the disclosure.

FIG. 8 is a side view of a side panel of an embodiment of the disclosure.

FIG. 9 is a side view of a side panel of an embodiment of the disclosure.

FIG. 10 is a top view of a roof panel of an embodiment of the disclosure.

FIG. 11 is a schematic view of an embodiment of a method of the disclosure.

### DETAILED DESCRIPTION OF THE INVENTION

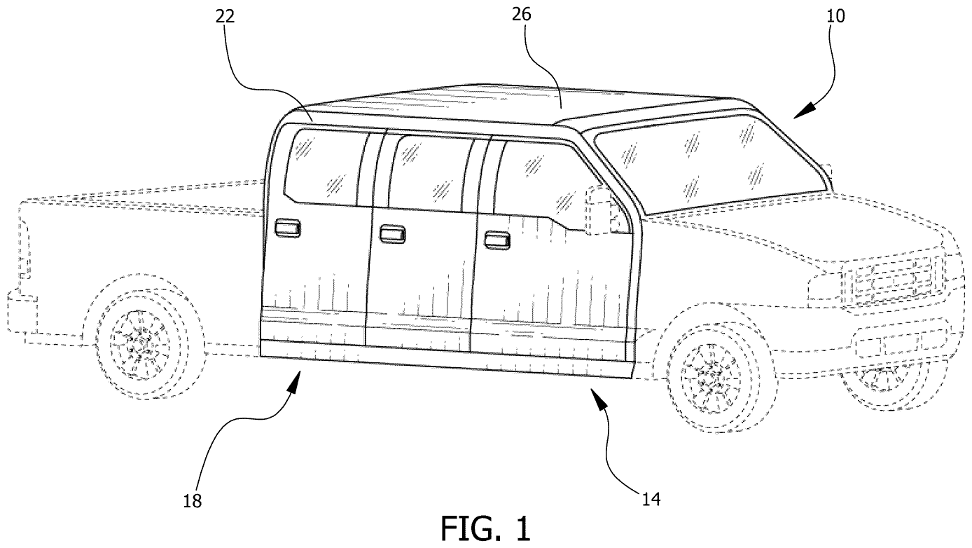

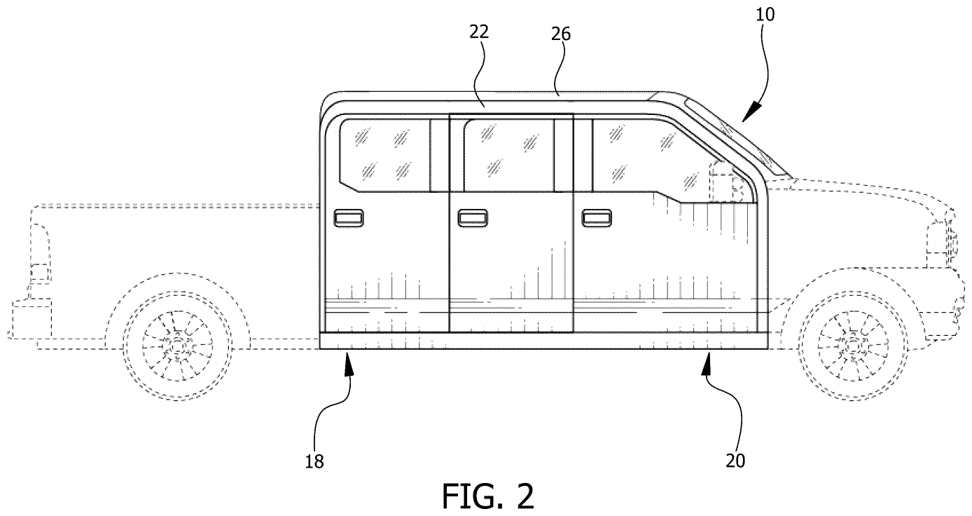

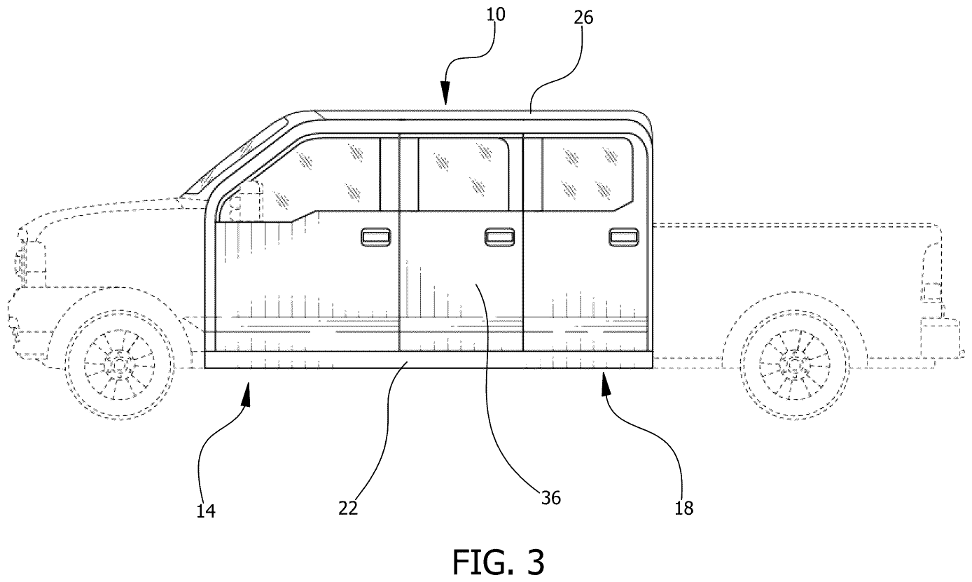

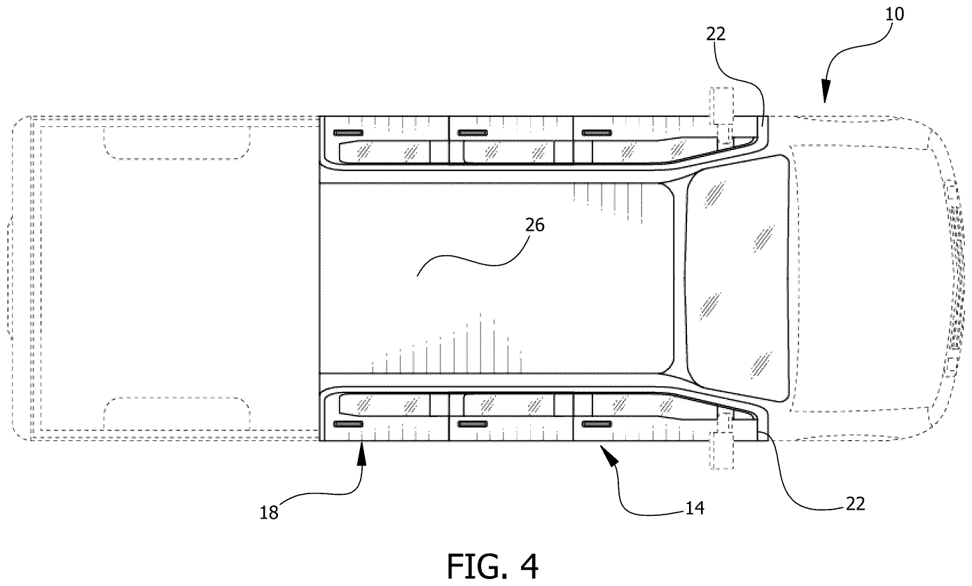

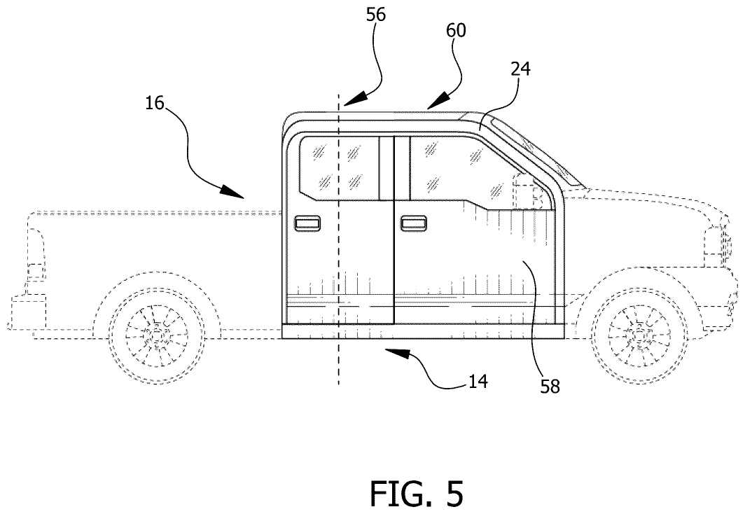

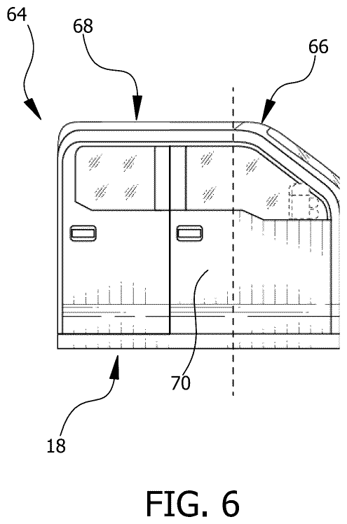

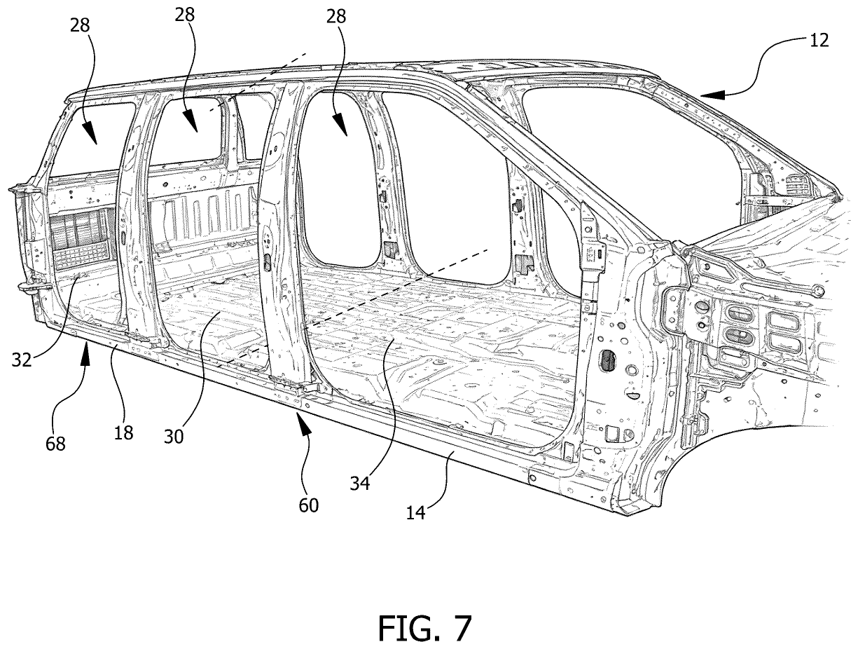

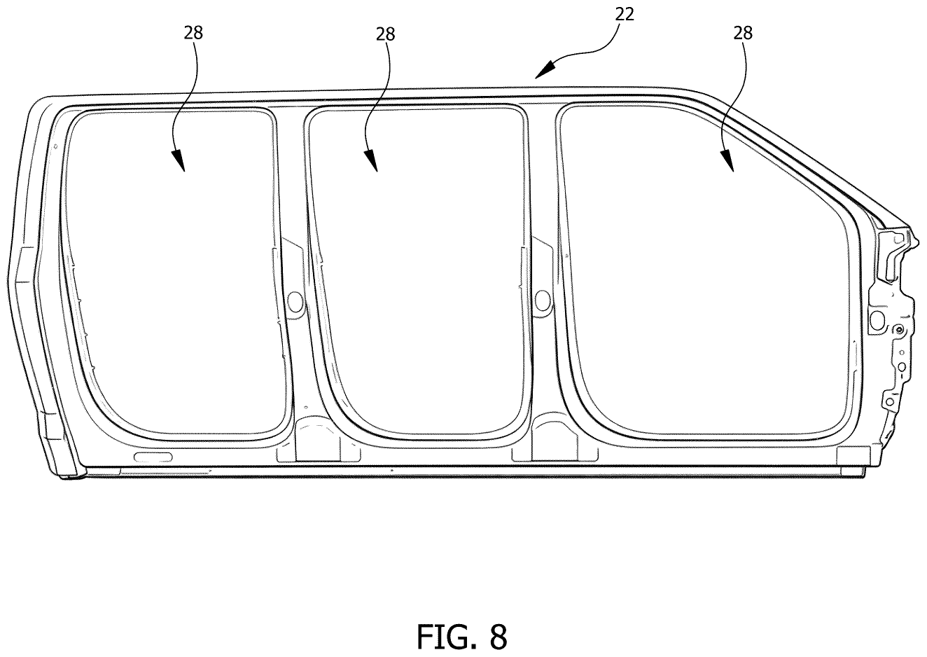

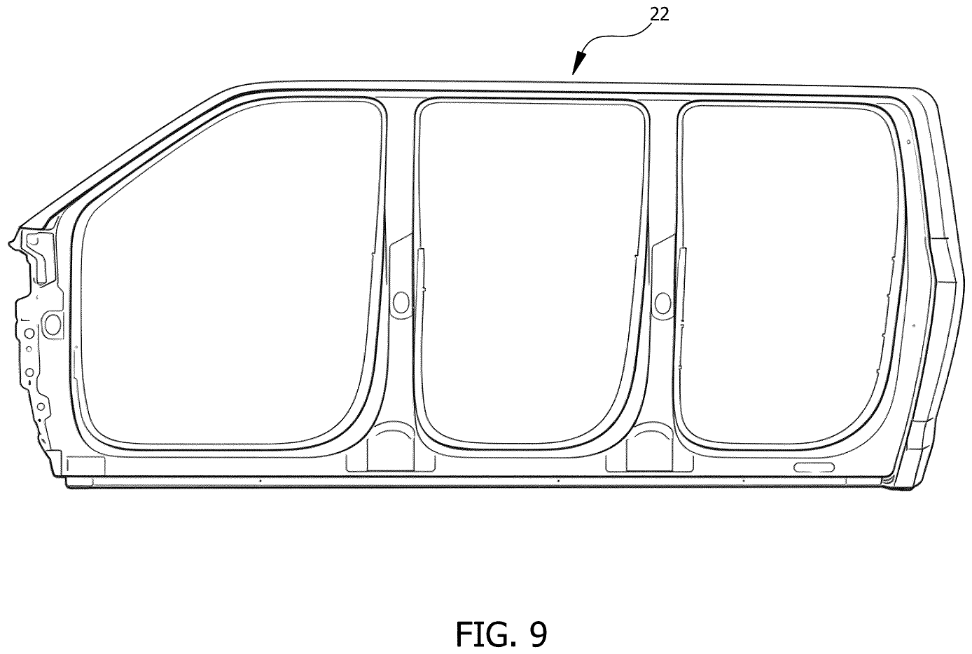

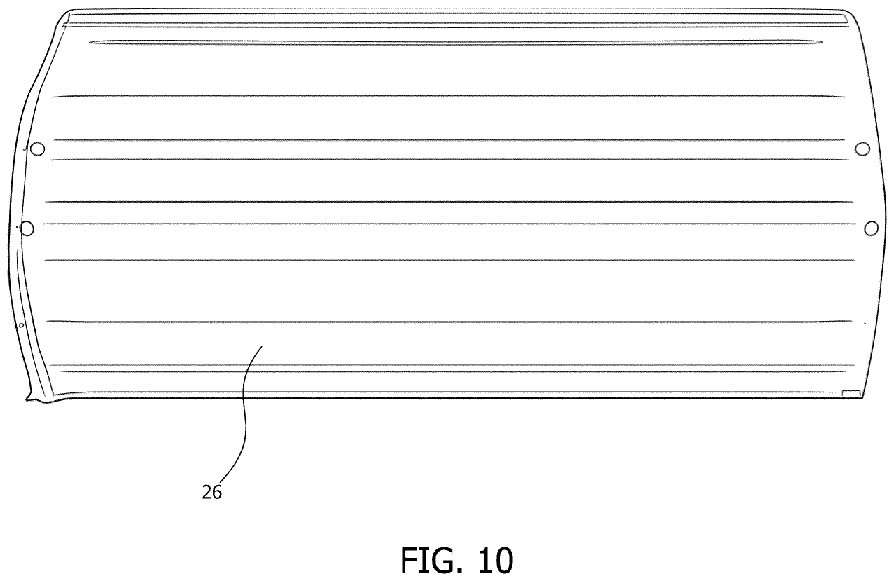

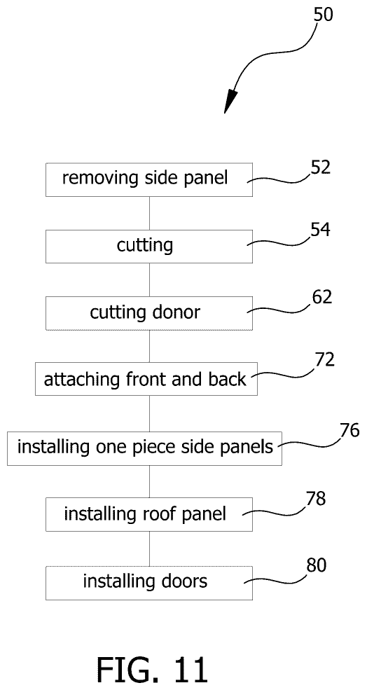

With reference now to the drawings, and in particular to FIGS. 1 through 11 thereof, a new pickup truck cab extension embodying the principles and concepts of an embodiment of the disclosure and generally designated by the reference numeral 10 will be described.

As best illustrated in FIGS. 1 through 11, the pickup truck cab extension 10 generally comprises an extended inner frame 12 formed by joining a first extended section 14 coming from a base vehicle 16 and a second extended section 18 from a donor frame 20. The extended inner frame 12 is covered by a pair of side panels 22 coupled to the extended inner frame 12. Each of the side panels 22 is a seamless one-piece fiberglass side panel construction such that there are no seams along a full side of the resulting pickup cab. Each side panel 22 excludes incorporation of any portion of a prior side panel 24 of the base vehicle 16. This is to avoid the conventional issue of cutting and rejoining portions of the prior side panel 24 on the base vehicle 16.

For further stability, rigidity and stiffness, a roof panel 26 is coupled to the extended inner frame 12. The roof panel 26 is also a single piece seamless fiberglass roof panel fully replacing any prior roof panel of the base vehicle 16.

Each side panel 22 has three door openings 28. A middle door opening 30 of the three door openings 28 is uniquely shaped relative to a rear door opening 32 of the three door openings 28. Further, the middle door opening 30 of the three door openings 28 is also uniquely shaped relative to a front door opening 34 of the three door openings 28. The rear door opening 32 of the three door openings 28 matches original equipment manufacture size for a rear door of the base vehicle 16. Similarly, the front door opening 34 of the three door openings 28 matches original equipment manufacture size for front doors of the base vehicle 16. Thus, only a middle door 36 must be manufactured to fit correctly the middle door opening 30. The middle door 36 can be formed by adhering two layers of seamless one-piece fiberglass together. Custom sizing of the middle door 36 is primarily in the peripheral areas or perimeter to fit the middle door opening 30. Thus, the middle door 36 can also accommodate use of original equipment manufacture of accessories or attachments required for the finished middle door such as handles, windows, and other attachments conventionally used in a vehicle door.

The above allows for a method 50 of extending a pickup truck cab. The method 50 includes a step 52 of removing original side panels and a roof panel from an existing pickup truck or base vehicle 16. The side panels are fully removed leaving no part of the original side panels connected to an underlying interior frame of the base vehicle 16. Another step 54 is cutting an interior frame of the existing pickup truck within a section 56 corresponding to a door of a cab of the existing pickup truck behind a front door 58 to create an extended front cab frame section 60. Typically the extension is from a four door to six door extended cab so the section 56 will correspond to a rear door of the existing pickup truck. Another step 62 is cutting a donor cab frame 64 within a section 66 corresponding to a front door 70 of the donor cab frame 64 to create an extended rear cab frame section 68. A next step 72 is attaching the extended front cab frame section 60 to the extended rear cab frame section 68 to produce the extended inner frame 12 having more door openings than the interior frame of the existing pickup truck, typically six total door openings. Yet another step 76 is installing side panels 22 to the extended inner frame 12. As described above, each of the side panels 22 is a seamless one-piece fiberglass side panel construction. A further step 78 is installing the roof panel 26 to the extended inner frame 12. The roof panel 26 is also a seamless one-piece fiberglass roof panel construction. Yet another step 80 is attaching doors to each of a plurality of door openings 28 of the extended inner frame 12.

In use, the disclosed device 10 and method 50 provide for a single connection line for extending an inner cab from while producing additional door openings between original sized front and rear door openings. The method 50 further requires a single frame connection with custom manufacture of only the side panels 22, roof panel 26, and a middle door 36 which minimizes custom manufacturing of parts by using original equipment manufacture components as described above. The exterior of the resulting extended cab vehicle will further have a clean and finished look due to the single piece side and roof panels.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method of extending a pickup truck cab, the steps of the method comprising:
removing original side panels and roof panel from an existing pickup truck;
cutting an interior frame of the existing pickup truck within a section corresponding to a door of a cab of the existing pickup truck behind a front door to create an extended front cab frame section;
cutting a donor cab frame within a section corresponding to a front door of the donor cab frame to create an extended rear cab frame section;
attaching the extended front cab frame section to the extended rear cab frame section to produce an extended inner frame having more door openings than the interior frame of the existing pickup truck;
installing side panels to the inner frame wherein each of the side panels is a seamless one-piece fiberglass side panel construction; and
installing a roof panel to the inner frame, the roof panel being a seamless one-piece fiberglass roof panel construction.

2. The method of claim 1, further comprising a step of attaching doors to each of a plurality of door openings of the extended inner frame.

3. The method of claim 1, wherein front door openings of the extended inner frame match original equipment manufacture size for front doors of the existing pickup truck.

4. The method of claim 1, wherein rear door openings of the extended inner frame match original equipment manufacture size for rear doors of the existing pickup truck.

5. An extended pickup truck cab, comprising:
an extended inner frame formed by joining a first extended section coming from a base vehicle and a second extended section from a donor frame; and
a pair of side panels coupled to the extended inner frame, each of the side panels being a seamless one-piece fiberglass side panel construction.

6. The extended pickup truck cab of claim 5, further comprising each side panel excluding incorporation of any portion of a prior side panel of the base vehicle.

7. The extended pickup truck cab of claim 5, further comprising a roof panel being coupled to the extended inner frame, the roof panel being a seamless fiberglass roof panel.

8. The extended pickup truck cab of claim 5, further comprising each side panel having three door openings.

9. The extended pickup truck cab of claim 8, further comprising a middle door opening of the three door openings being uniquely shaped relative to a rear door opening of the three door openings.

10. The extended pickup truck cab of claim 8, further comprising a middle door opening of the three door openings being uniquely shaped relative to both a front door opening of the three door openings and a rear door opening of the three door openings.

11. The extended pickup truck cab of claim 8, wherein rear door opening of the three door openings matches original equipment manufacture size for a rear doors of the base vehicle.

12. The extended pickup truck cab of claim 8, wherein front door opening of the three door openings matches original equipment manufacture size for a front doors of the base vehicle.
